(19) United States
(12) Patent Application Publication
(10) Pub. No.: US 2011/0318161 A1
(43) Pub. Date: Dec. 29, 2011

(54) APPARATUS, SYSTEM AND METHOD FOR A WIND TURBINE

(76) Inventor: Goran Miljkovic, Kitchener (CA)

(21) Appl. No.: 13/169,532

(22) Filed: Jun. 27, 2011

Related U.S. Application Data
(60) Provisional application No. 61/358,654, filed on Jun. 25, 2010.

(51) Int. Cl. F03D 7/06

(52) U.S. Cl. 415/1; 415/4.2

(57) ABSTRACT

A wind turbine apparatus having a plurality of blades, a shaft connecting the blades and a housing for the blades. The housing is configured to provide an operational angle of over approximately 90 degrees. A wind turbine system having at least one wind turbine apparatus with a housing having a top enclosure and a bottom enclosure. The wind turbine system also includes a post pivotally connected to the at least one wind turbine apparatus and an electrical generator operatively connected to the at least one wind turbine apparatus. A method of wind tunneling wind to a wind turbine apparatus, which includes routing wind towards withdrawing blades of a wind turbine apparatus via a top enclosure; and routing wind towards arising blades of a wind turbine apparatus via angled slots provided in a bottom enclosure.

### FIELD

This patent application claims priority on U.S. Provisional Patent Application 61/358,654 filed Jun. 25, 2010, which is hereby incorporated by reference.

This present document relates to wind turbines. More particularly, the present document relates to an apparatus, system and method intended to increase efficiency of wind turbines.

### BACKGROUND

With the growing interest in alternative forms of generating energy, greater interest is being given to wind and solar power. Conventional wind turbines allow for the conversion of kinetic energy from the wind to mechanical energy used to produce electricity. The electricity may be fed into a grid or may be used by an individual to power specific devices.

A conventional wind turbine may have difficulties performing during low wind speeds and may become damaged during high wind speeds. There is a need for a wind turbine that is intended to generate electricity at various wind speeds.

### SUMMARY

In one aspect, a wind turbine apparatus is provided having, a plurality of blades; a rotor assembly connecting the blades; and a housing configured to provide an operational angle of over approximately 90 degrees.

In some cases, the housing includes a top enclosure and a bottom enclosure. The top enclosure of the housing has a slanted top surface designed to deflect wind.

In some cases, the top enclosure of the housing is movable from an open position to a closed position. The top enclosure may be programmed to move between the open position to the closed position based on wind speed. In some cases, the top enclosure is configured to pivot over 90 degrees between the open position and the closed position.

The bottom enclosure of the housing of the wind turbine apparatus may include a plurality of angled slots. In some cases, the plurality of angled slots at an angle of approximately 20 to 55 degrees from horizontal.

Each blade of the plurality of blades of the wind turbine apparatus may be tapered from a bottom edge to a top edge. In some cases, the blades are connected to a shaft via a rotor assembly such that there is a gap between a base of each blade and the shaft. In some cases each blade has a capture projection at a top edge of the blade.

In another aspect, a wind turbine system is provided wherein the wind turbine system has at least one wind turbine apparatus having: a plurality of blades; a rotor assembly connecting the blades; and a housing for the blades, the housing is configured to provide an operational angle of over approximately 90 degrees. The wind turbine system further includes a post pivotally connected to the at least one wind turbine apparatus; and an electrical generator operatively connected to the at least one wind turbine apparatus.

In some cases, the post is connected to a rail and the housing further comprises a wheel assembly wherein the wheels aid in pivoting the at least one wind turbine to the direction of the wind.

In other cases, the wind turbine system includes at least one pair of wind turbine apparatuses, each pair of wind turbine apparatuses being pivotally connected to the post.

In some cases, the housing of the wind turbine apparatus is movable from an open position to a closed position. In some cases, the housing has a top enclosure that is configured to pivot over 90 degrees between the open position and the closed position.

In some cases, the housing has a bottom enclosure which includes a plurality of angled slots. In some cases, the plurality of angled slots are at an angle of approximately 20 to 55 degrees from horizontal.

In yet another aspect, a method of wind tunneling wind to a wind turbine apparatus is provided, the method including: routing wind towards withdrawing blades of a wind turbine apparatus via a top enclosure; and routing wind towards rising blades of a wind turbine apparatus via angled slots provided in a bottom enclosure.

Other aspects and features will become apparent to those ordinarily skilled in the art upon review of the following description of specific embodiments in conjunction with the accompanying figures.

### BRIEF DESCRIPTION OF THE DRAWINGS

Embodiments will now be described, by way of example only, with reference to the attached Figures, wherein:

FIG. 1 illustrates a perspective view of a wind turbine system according to an embodiment;

FIG. 2 illustrates a perspective view of a wind turbine apparatus;

FIG. 3 illustrates a cross section view of a wind turbine apparatus;

FIG. 4 illustrates a perspective view of the blade assembly of the wind turbine apparatus according to an embodiment;

FIG. 5 illustrates a perspective view of a top enclosure for a wind turbine apparatus;

FIGS. 6A and 6B illustrate a perspective front and back view of a bottom enclosure for a wind turbine apparatus;

FIG. 7 illustrates a perspective view of a closing mechanism for a wind turbine apparatus;

FIGS. 8A and 8B illustrate a rotor assembly for a wind turbine apparatus;

FIG. 9 illustrates a cross section view of a wind turbine apparatus illustrating the wind tunneling concept;

FIG. 10 illustrates a perspective view of a wind turbine apparatus in a closed position;

FIG. 11 illustrates an alternative embodiment of a wind turbine system;

FIG. 12 illustrates yet another alternative embodiment of a wind turbine system; and

FIGS. 13A and 13B illustrate a cross section and a perspective view of an alternative embodiment of a blade of a wind turbine apparatus.

### DETAILED DESCRIPTION

It will be understood that the examples given are for illustration purposes only and that any specific limitations are indicated only for ease of understanding of the examples and may be modified as understood by one of skill in the art.

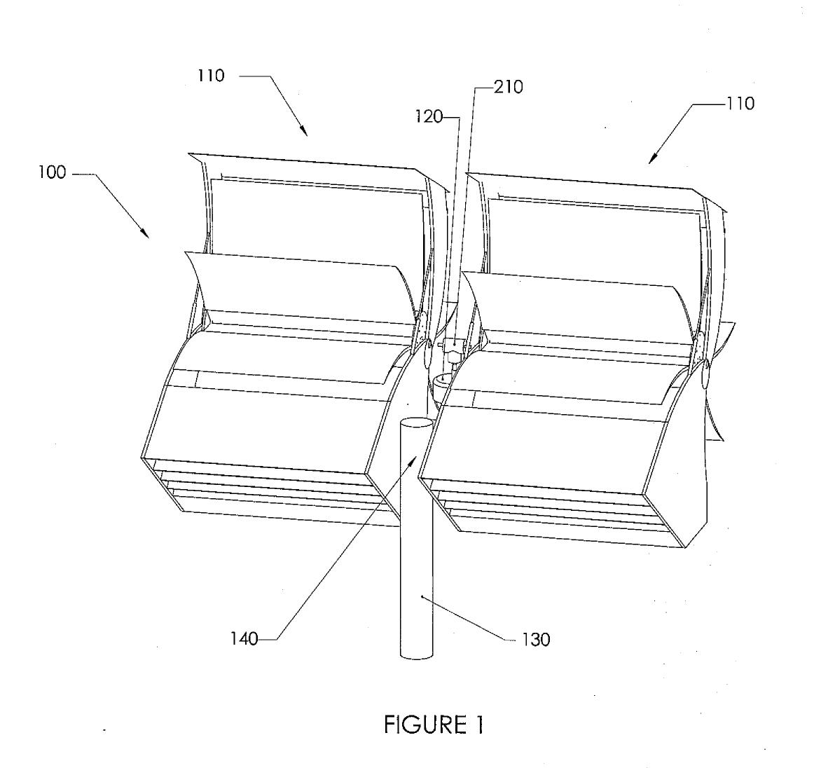

FIG. 1 illustrates a horizontal axis wind turbine system 100 having two wind turbine apparatuses 110 connected in parallel. In this example, the wind turbine apparatuses include a generator 120 between the wind turbines and are pivotally connected to a mounting mechanism, for example, a pole 130. The pole 130 may be fastened to the ground or another structure intended to support the wind turbine system 100. Although FIG. 1 is illustrated with two wind turbines apparatuses 110, it will be understood that only one wind turbine apparatus could be used or a plurality of wind turbine apparatus pairs could be incorporated along the mounting structure of the wind turbine system. It will be further understood that, in some cases, the wind turbine apparatus may be arranged in a vertical orientation. The wind turbine system further includes attachment system 140 allowing for unhindered horizontal rotation of 360 degrees around the pole 130. As the horizontal rotation is unhindered, the wind turbine system apparatus may self-position in relation to the wind direction, for example, by being turned toward more intense wind by the force of the wind.

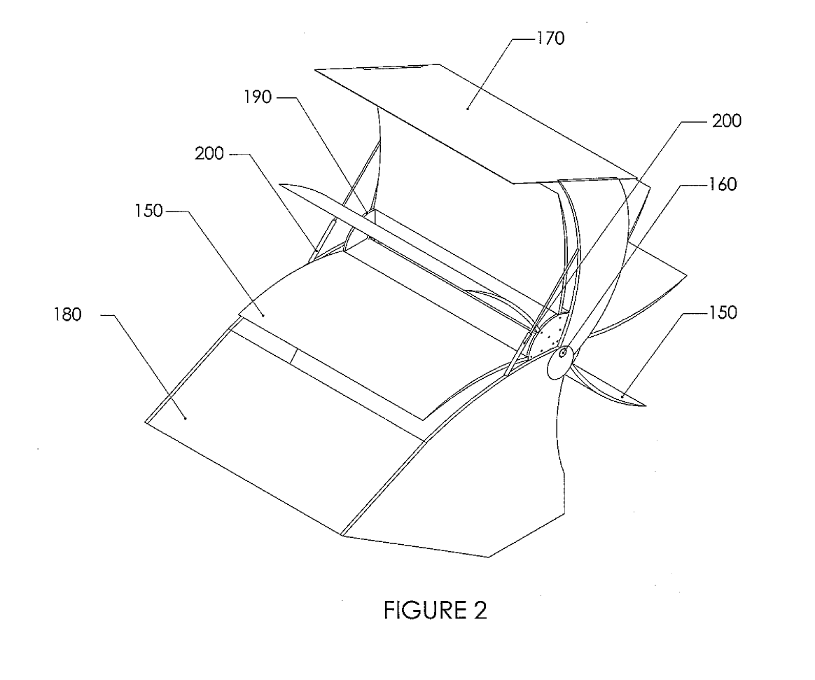

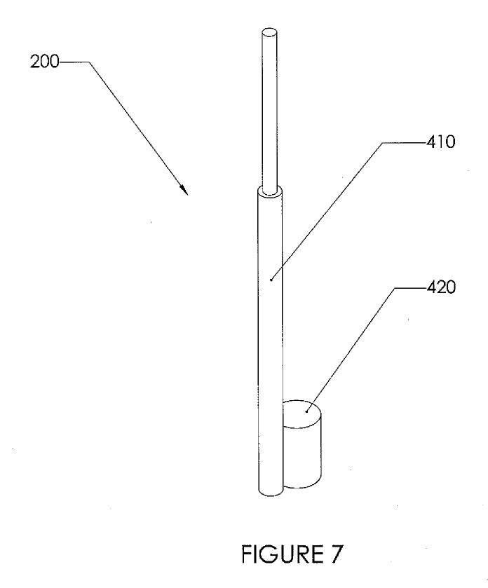

FIG. 2 illustrates a perspective view an embodiment of the wind turbine apparatus 110. The wind turbine apparatus 110 includes a plurality of blades 150, a shaft 160, and a housing having a top enclosure 170 and a bottom enclosure 180. Although shown as separate parts, the top enclosure 170 and bottom enclosure 180 may be integrated. It will be understood that the number of blades could be more or less depending on the size and configuration of the wind turbine apparatus 110. Each of the plurality of blades 150 are connected to the shaft 160 via a rotor assembly plate 190. In this example, the blades may be spaced equidistance from one another. The top enclosure 170 and the bottom enclosure 180 are designed with an appropriate shape, which may vary whether the wind turbine apparatus is configured as is a horizontal or vertical wind turbine. The top enclosure 170 may be movably connected to the bottom enclosure 180 through a closing mechanism 200 as shown in FIG. 7. The closing mechanism 200 may also aid in stopping the top enclosure 170 from creating an overly large opening.

The shaft 160 is positioned horizontal to the ground. The shaft 160 may be further connected to a driving mechanism 210 of the generator 120 (as shown in FIG. 1), which then converts the kinetic energy harnessed from the wind and wind turbine apparatus movement into electrical power.

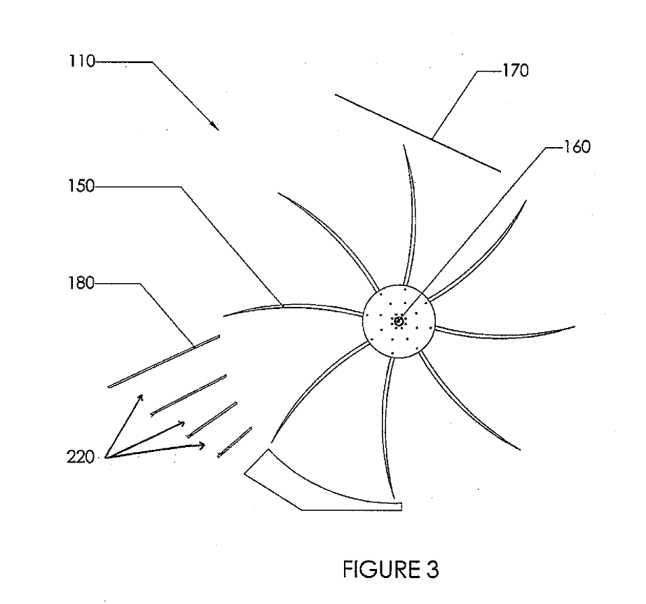

A cross section of the wind turbine apparatus 110 is shown in FIG. 3. The bottom enclosure 180 includes a plurality of angled slots 220 to allow wind to flow through to generate additional kinetic energy when compared with a fully closed bottom enclosure 180. The angled slots are configured to direct air flow to drive the rotation of the blades. The top enclosure 170 may be slanted or inclined, which is intended to be more aerodynamic than a flat top enclosure. In some cases, the top enclosure may be curved or have another appropriate shape.

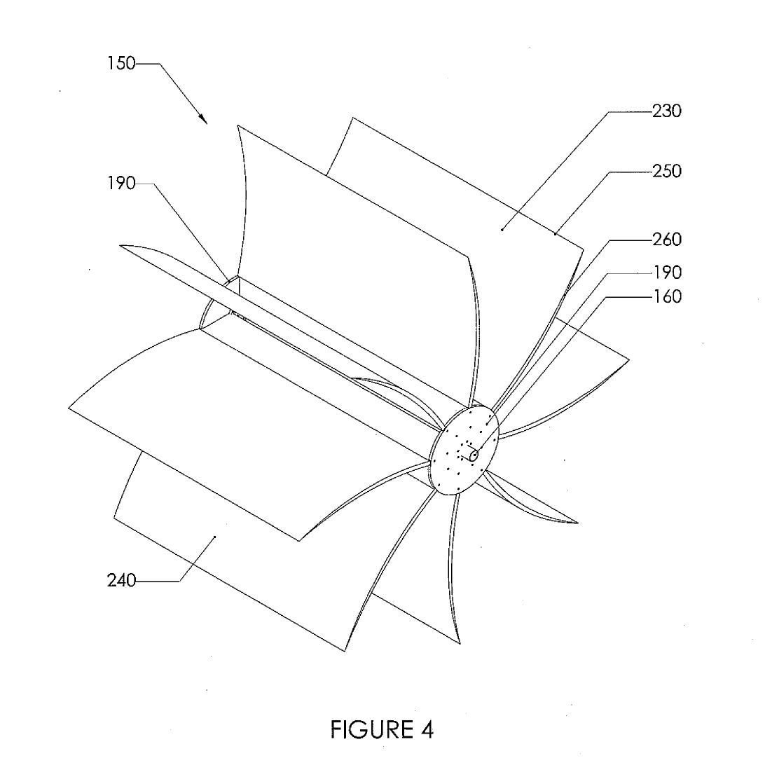

The blade assembly is further detailed in FIG. 4. Each blade 150 has a front surface 230 and a back surface 240. Each blade has a top 250, a bottom and side edges 260. As shown, the front surface 230 and back surface 240 may be curved surfaces and the blade may be tapered towards the top 250. The blades may be an appropriate aerodynamic shape. The side edges and/or the bottom edge of the blades 150 may be connected to the shaft 160, directly, or, as in the case, via a rotor assembly plate 190.

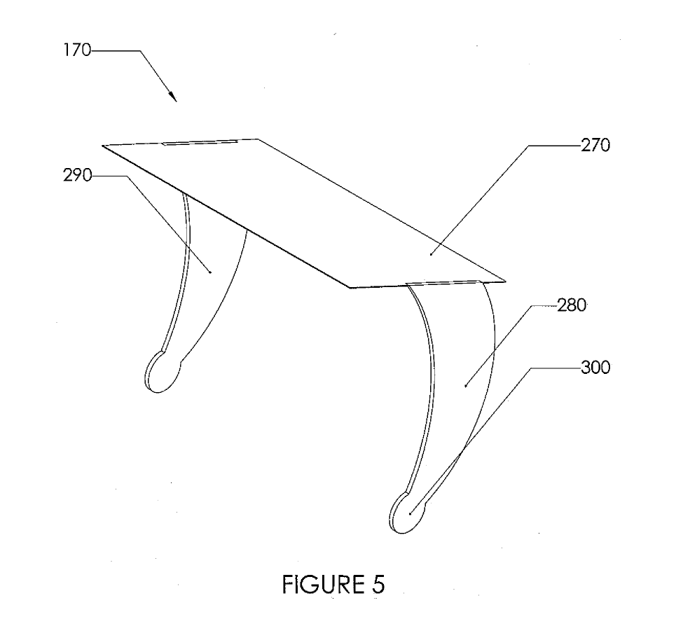

The top enclosure 170 is further illustrated in FIG. 5 and includes a top side 270, a left side 280 and a right side 290, which together form a wind-tunneling device. The top enclosure may be positioned such that the bottom 300 of the top enclosure is at the level or above the central axis of the shaft 160. The left side 280 and right side 290 of the top enclosure 170 may be interconnected with a left side and a right side of the bottom enclosure 180. The longitudinal position of the top enclosure 170 is configured to vary over about 90 degrees, and may be programmed to move depending on the strength of the wind. The top enclosure 170 may rotate towards the front of bottom enclosure 180 during periods of high wind strength to reduce the wind strength on the blades 150. During periods of reduced wind strength, the top enclosure 170 may rotate away from the front of the bottom enclosure 180 to allow more wind to reach the blades 150. The bottom side 300 of top enclosure 170 is open and an inner part of enclosure is shaped and spaced to accommodate blade rotation. A nominal or start position of the top enclosure 170 is set at a nominal wind speed, and corresponds to an open position. During rising wind speeds top enclosure 170 moves forward towards a closed position, which is intended to prevent direct exposure of the blades to the wind as well as to deflect wind away from blades, as described in further detail herein.

In some cases, the top enclosure 170 may have a curved surface. In other cases, the top enclosure 170 may have a flat surface designed to receive a solar cell panel. The incorporation of a solar cell panel may have a dual function in that the solar cell panel may aid in wind deflection and may increase energy generation during sunny periods.

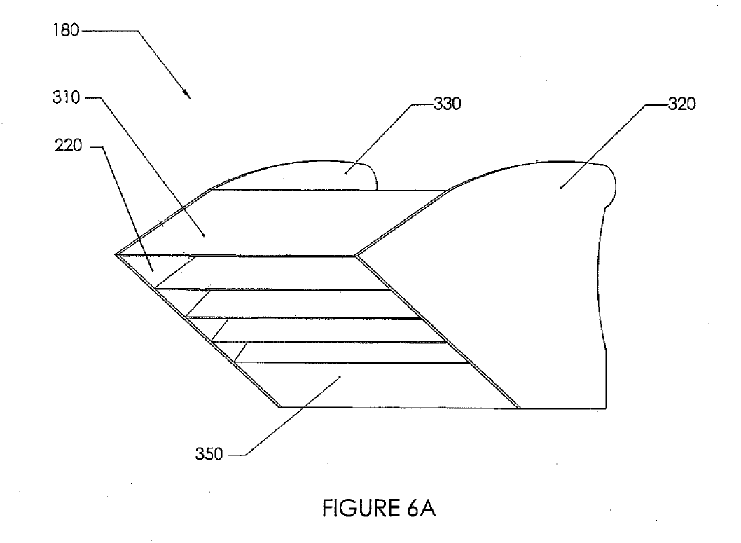

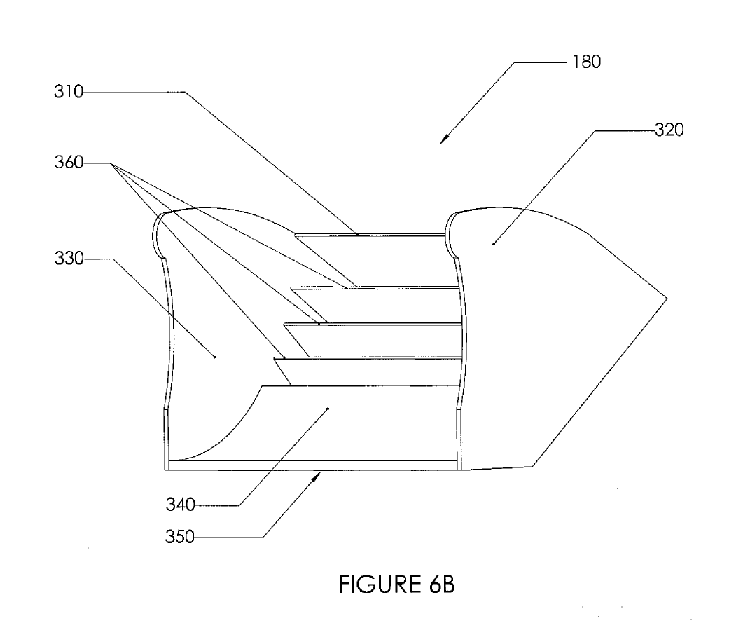

FIGS. 6A and 6B further illustrate the bottom enclosure 180, which includes upper front surface 310, the left side 320, the right side 330 and a shaped inner side 340 forming a wind-tunneling device. The lower front side includes the plurality of angled slots 220 or openings orientated towards wind direction and intended to direct wind at the rising blades 150. The bottom enclosure 180 is positioned such that the top of the bottom enclosure 180 is at the level or below the central axis of the shaft 160. The upper front surface 310 has a leading edge at about 20 to 55 degrees from the horizontal orientated towards rising blades. In some cases, and as shown, the angle is about 45 degrees from the horizontal. In other cases, larger or smaller angles may also work to redirect the wind. Although four angled slots are shown, more or less slots of appropriate spacing may be used in order to redirect the wind towards the blades 150.

The plurality of angled slots 220 are divided by angled walls 360 positioned at about 20 to 55 degrees from the horizontal. In some cases, the angle of the angled walls 360 are 45 degrees from the horizontal, which is intended to position the wind flow towards the blades 150, although other angles may also position the wind flow adequately. In other cases, the angled walls will be angled differently and may be less angled nearer to the top surface of the bottom enclosure 180. The left side 320 and right side 320 of the bottom enclosure 180 may be interconnected with the left side and right side of the top enclosure 170 respectively to create a hinged housing for the blades. A backside of the bottom enclosure 180 may be open, while an inner side 340 of the bottom enclosure 180 is shaped and spaced to accommodate blade rotation.

FIG. 7 illustrates a perspective view of an example of the closing mechanism 200 having a servomotor 410 and a bar 420 or shaft. An external control unit (not shown) can be used to control the servomotor 410 positioning. In some configurations the top enclosure 170 may be connected to the bottom enclosure 180 with a mechanical arm to keep the top enclosure 170 in a static, predetermined position but it is preferable if the top enclosure 170 can move at least between an open and a closed position.

Other closing mechanisms 200 may be used. In some cases, motors on either side of the top enclosure 170 may be attached to the top enclosure. The motors may be controlled by an external control unit. The external control unit may operate the motors which may pivot or move the top enclosure. In other cases, the closing mechanism may include a spring system and may be operated based on the strength of the wind by having an appropriately shaped top enclosure or an external appropriately shaped mechanism. During periods of high wind, the springs may be compressed allowing for the top enclosure to pivot into a closed position. When the wind strength is reduced, the spring is intended to decompress and pivot the top enclosure to a more open positioned. It will be understood that other closing mechanisms 200 may also be used to move the top enclosure 170 from an open position to a closed position.

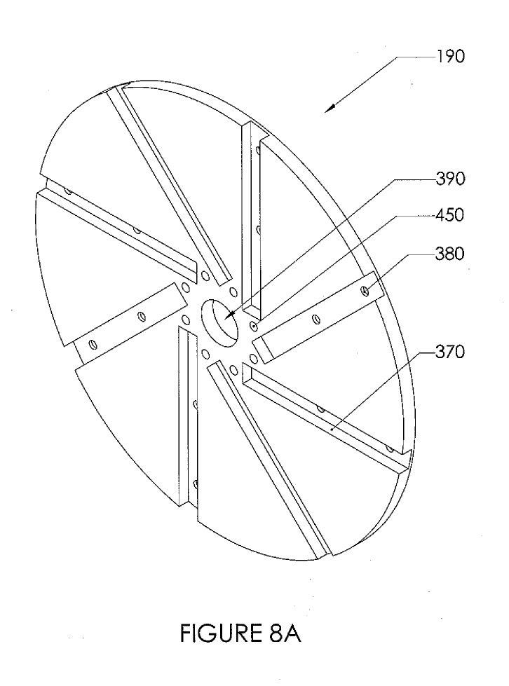

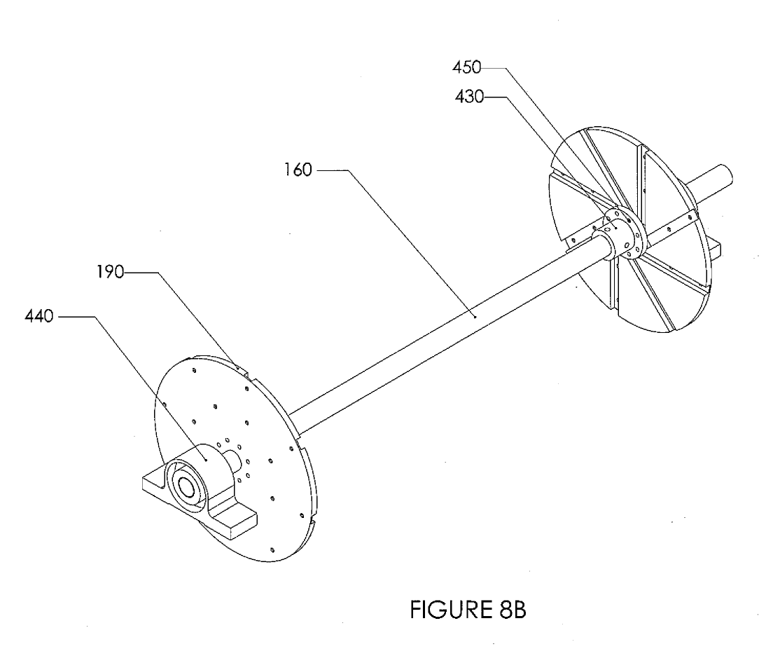

FIG. 8A illustrates an example of the rotor assembly plate 190 adapted to receive the blades 150 and connect the blades to the shaft 160. In this example, the blades 150 are be fitted into recesses 370 and attached to the rotor assembly 190 via fasteners such as screws or adhesive. If screws are used, the rotor assembly 190 may include apertures 380 designed to receive the screws. The rotor assembly plate 190 also includes a shaft aperture 390 designed to receive the shaft. In some cases, the recess 370 will not extend the full length of the rotor assembly plate 190 and will secure the blade 150 above the shaft, leaving a gap between the blade 150 and the shaft 160. The gap between the blade 150 held in the recess 370 and the shaft 160 is intended to reduce build up of debris such as dirt, rain or snow by making it possible for the debris to fall through the gap.

FIG. 8B illustrates a rotor assembly having a rotor assembly plate 190 located near each end of the shaft 160. The wind turbine apparatus is intended to have a rotor assembly plate 190 on either end of the shaft 160 for supporting the blades 150.

The rotor assembly plate 190 is connected to the shaft 160 via a shaft fitting 430 and with the shaft 160 and rotor assembly. The shaft 160 may be provided with into a ball bearing assembly 440 on either end of the shaft 160.

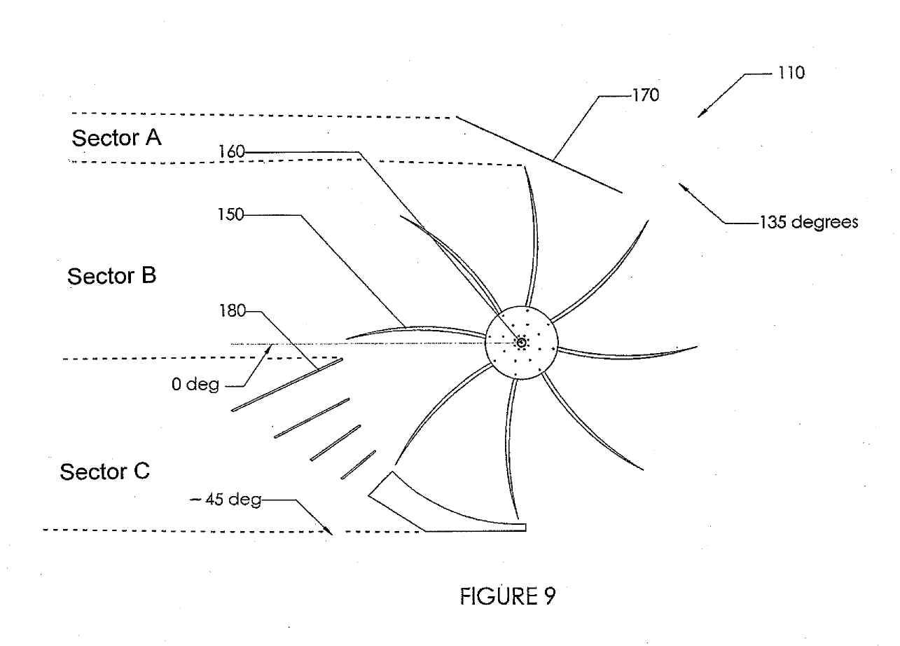

FIG. 9 illustrates a cross section of an example wind turbine apparatus 110 which is configured to create a wind tunneling effect. FIG. 9 shows the use of wind turbine apparatus 110 in an elevated and horizontal orientation. It should be noted that the wind turbine may be positioned on any level where the wind turbine can receive wind in any horizontal direction of 360 degrees. It should also be noted that the wind turbine may operate in a vertical orientation, although, the bottom enclosure 180 may need to be moveable in this orientation.

The wind turbine apparatus as illustrated has both top enclosure 170 and bottom enclosure 180, which can be made from metal, fiber, reinforced plastic, composite material or other suitable conventional engineering material. Since the entire apparatus needs to be responsive towards wind direction, it is preferred that the selected materials be as light in weight as possible and also resistive to mechanical stress.

The method of using the wind turbine apparatus 110 is based on multidirectional wind kinetic energy. The top enclosure 170 and bottom enclosures 180 form a wind-tunneling device that is intended to improve wind turbine efficiency. The wind turbine system 100 may rotate around a horizontal axis in order to be positioned directly into the wind direction. Further, the top enclosure 170 may be opened or closed to increase or reduce the size of the wind-tunneling area in an effort to increase or reduce the amount of wind passing through the wind turbine apparatus 110.

Incoming wind can be considered as divided into three sectors. Sector (A) represents incoming wind moving towards the top enclosure 170. Sector (B) represents wind generally perpendicular in respect of the blade assembly. Sector (C) represents wind moving towards the bottom enclosure 180.

Sector (A), with reference to FIG. 9, represents incoming wind moving towards the top enclosure 170. The top enclosure 170 is configured on an angle such that the wind will be routed towards withdrawing blades comprising an operational angle from about 90 to 180 degrees in relation to the horizontal. The top enclosure in the position shown in FIG. 9 is intended to have at least these following functions:

a. to route the wind towards withdrawing blades keeping wind kinetic energy focused on withdrawing blades;

b. to extend the operational angle about 90 degrees (i.e. from 90 to 180 degrees) in respect of wind direction; and

c. to provide a longitudinal positional angle for the best performance of the wind turbine (low/high wind speed).

Sector (B) represents wind kinetic energy generally perpendicular in respect of a vertical blade where operational field is between about 0 degrees to 90 degrees in relation to the horizontal. This is the conventional wind ranged used in a turbine of this type.

Sector (C) represents wind moving towards the bottom enclosure 180. The bottom enclosure 180 is intended to have at least the following functions:
a. to route the wind towards rising blades and support movement from about 0° angle towards about 90° of rotation;
b. to route wind through the enclosure slits towards rising help drive blades from about −45° towards about 0°; and
c. to prevent wind counter force from slowing down incoming blades, which are traveling opposite to the wind direction.

FIG. 9 illustrates that the wind tunneling provided by the enclosures can provide for approximately 180 degrees or more of effective use of the wind kinetic energy. The top and bottom enclosures are intended to be designed in order to optimize the wind tunneling effect.

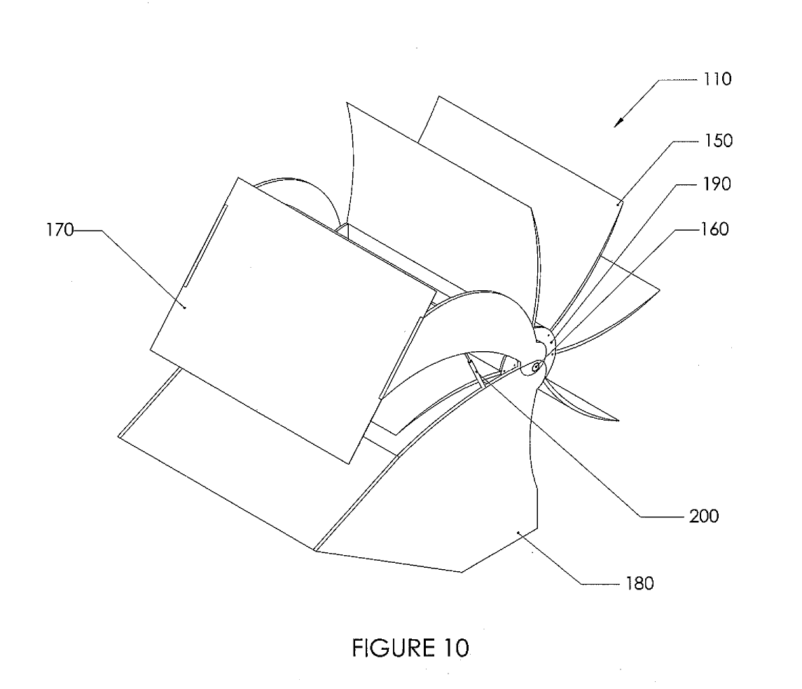

FIG. 10 illustrates the wind turbine apparatus 110 when the housing encompassing the top enclosure 170 is in a closed position in relation to the bottom enclosure 180. The closed position is intended to be used during times of high wind strength and is intended to provide protection to the blades 150. This protection may reduce the likelihood of the blades 150 being damaged and may reduce the mechanical stress on the blades 150. The wind turbine apparatus 110 may still generate mechanical energy from kinetic energy in a closed position as the slots in the bottom enclosure 180 may continue to allow wind to enter the housing and provide rotation to the blades. In an alternative, the top enclosure 170 may be constructed to extend further and, when in a closed position, extend past the angled slots of the bottom enclosure thereby significantly reducing or eliminating the wind that may enter the wind turbine apparatus 110.

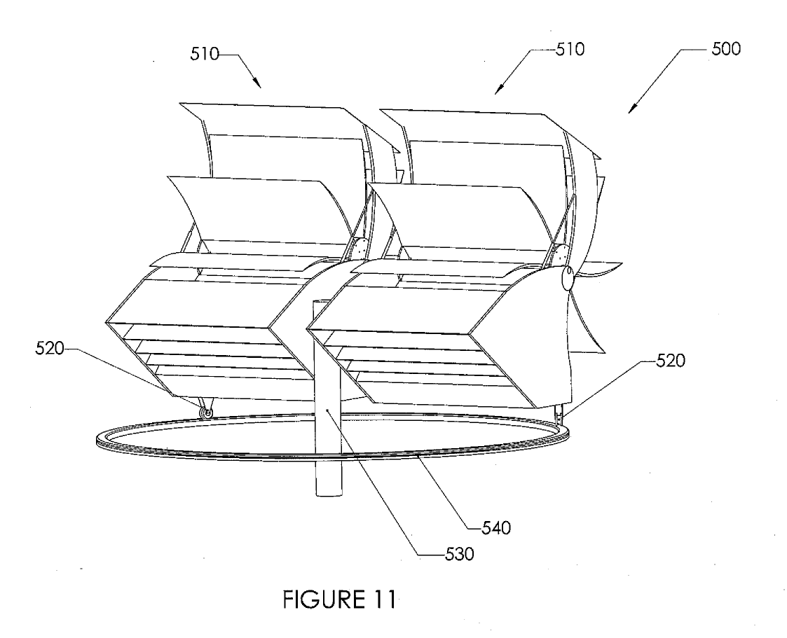

FIG. 11 illustrates an alternative embodiment of a wind turbine system 500. The wind turbine system 500 includes two wind turbine apparatuses 510. The wind turbine apparatuses have a top enclosure 570 and a bottom enclosure 580 designed to operate as described herein. The wind turbine apparatuses 510 are pivotally attached to a post 530. The post may be connected to a rail 540 or circular track. The wind turbine apparatuses 510 may further include a wheel assembly 520 designed to roll on the rail 540 to aid in the pivoting of the wind turbine apparatuses 510 towards the wind direction. The wheel assembly 520 may be attached to the bottom enclosure 580 or may be integrated such that the wheel assembly integrally extends from the bottom enclosure.

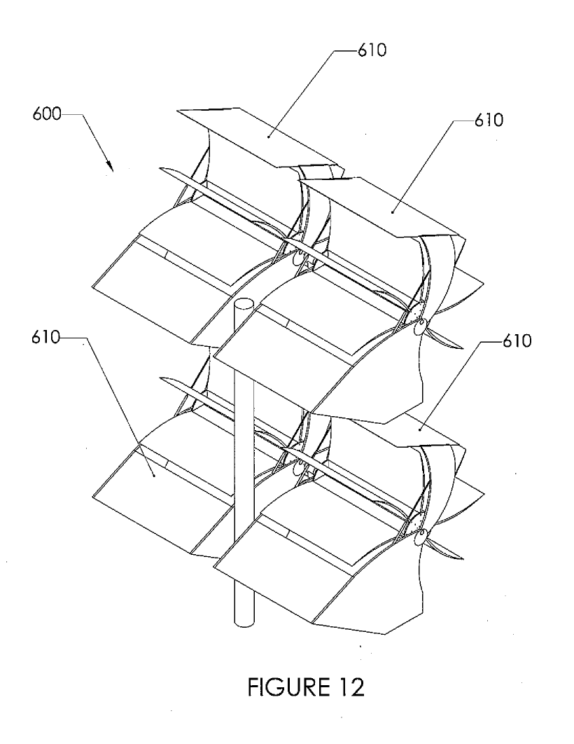

FIG. 12 illustrates yet another alternative embodiment of a wind turbine system 600. The wind turbine system 600 includes two pairs of two wind turbine apparatuses 610, similar to the modules 110. Each pair is pivotally attached to a post 630, and illustrates a vertical stacking configuration. Further pairs of wind turbines may be added along the length of the post 630.

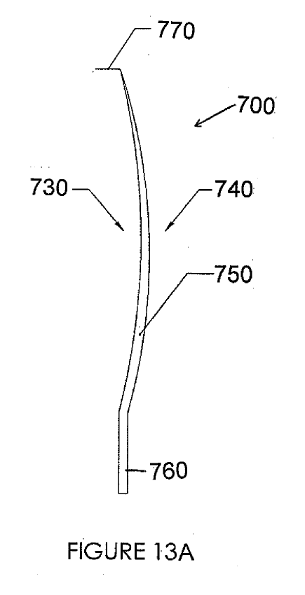

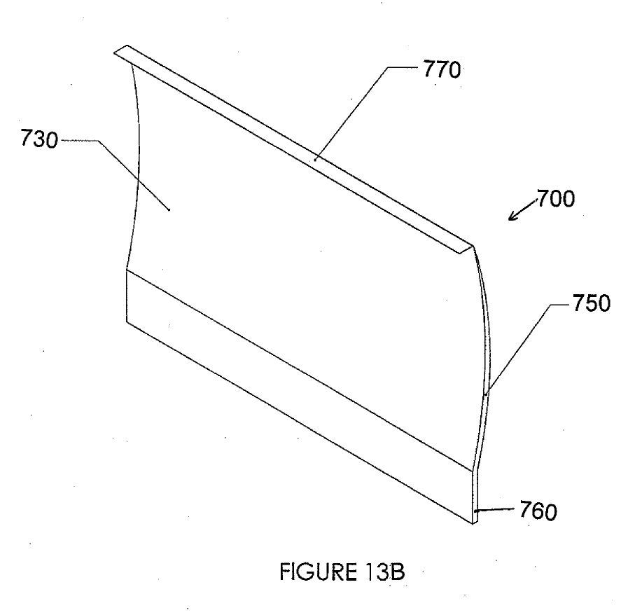

FIG. 13A and 13B illustrate an alternative embodiment of a blade 700. The blade 700 has a front surface 730 and a back surface 740. The blade 700 may have a curved body section 750 and a flat bottom section 760 designed to be received by the rotor assembly plate 190. Extending from the top of the blade 700 is a projection 770 or capture element designed to capture wind energy.

In the preceding description, for purposes of explanation, numerous details are set forth in order to provide a thorough understanding of the embodiments. However, it will be apparent to one skilled in the art that these specific details may not be required in order to practice the embodiments. In other instances, some structures may be shown in simplified or block diagram form in order not to obscure the embodiments.

The above-described embodiments are intended to be examples only. Those of skill in the art can effect alterations, modifications and variations to the particular embodiments without departing from the scope, which is defined solely by the claims appended hereto.

We claim:

1. A wind turbine apparatus comprising:
a plurality of blades;
a rotor assembly connecting the blades; and
a housing for the blades, the housing is configured to provide an operational angle over approximately 90 degrees.

2. The wind turbine apparatus of claim 1 wherein the housing comprises a top enclosure and a bottom enclosure.

3. The wind turbine apparatus of claim 2 wherein the top enclosure has a slanted top surface designed to deflect wind.

4. The wind turbine apparatus of claim 2 wherein the top enclosure is movable from an open position to a closed position.

5. The wind turbine apparatus of claim 4 wherein the top enclosure is programmed to move between the open position to the closed position based on wind speed.

6. The wind turbine apparatus of claim 4 wherein the top enclosure is configured to pivot over 90 degrees between the open position and the closed position.

7. The wind turbine apparatus of claim 1 wherein the bottom enclosure comprises a plurality of angled slots.

8. The wind turbine apparatus of claim 7 wherein the plurality of angled slots are at an angle of approximately 20 to 55 degrees from horizontal.

9. The wind turbine apparatus of claim 1 wherein the blades are connected to a shaft via the rotor assembly such that there is a gap between a base of each blade and the shaft.

10. The wind turbine apparatus of claim 1 each blade comprises a capture projection at a top edge of the blade.

11. A wind turbine system comprising:
at least one wind turbine apparatus comprising:
a plurality of blades;
a rotor assembly connecting the blades; and
a housing for the blades, the housing configured to provide an operational angle of over approximately 90 degrees;
a post pivotally connected to the at least one wind turbine apparatus; and
an electrical generator operatively connected to the at least one wind turbine apparatus.

12. The wind turbine system of claim 11 wherein the post is connected to a rail and the housing further comprises a wheel assembly wherein the wheels aid in pivoting the at least one wind turbine to the direction of the wind.

13. The wind turbine system of claim 11 comprising at least one pair of wind turbine apparatuses, each pair of wind turbine apparatuses being pivotally connected to the post.

15. The wind turbine system of claim 11 wherein the housing of the wind turbine apparatus is movable from an open position to a closed position.

16. The wind turbine system of claim 15 wherein the housing comprises a top enclosure wherein the top enclosure is configured to pivot over 90 degrees between the open position and the closed position.

17. The wind turbine system of claim 11 wherein the housing comprises a bottom enclosure, wherein the bottom enclosure comprises a plurality of angled slots.

18. The wind turbine system of claim 18 wherein the plurality of angled slots are at an angle of approximately 20 to 55 degrees from horizontal.

19. A method of wind tunneling wind to a wind turbine apparatus comprising:
routing wind towards withdrawing blades of a wind turbine apparatus via a top enclosure; and
routing wind towards arising blades of a wind turbine apparatus via angled slots provided in a bottom enclosure.

20. The method of claim 19 wherein the angled slots are at an angle of approximately 20 to 55 degrees from horizontal.
